(19) United States
(12) Patent Application Publication
(10) Pub. No.: US 2023/0368113 A1
(43) Pub. Date: Nov. 16, 2023

(54) MANAGING DISRUPTION BETWEEN ACTIVITIES IN COMMON AREA ENVIRONMENTS

(71) Applicant: INTERNATIONAL BUSINESS MACHINES CORPORATION, ARMONK, NY (US)

(72) Inventors: Hemant Kumar Sivaswamy, Pune (IN); Venkata Vara Prasad Karri, Visakhapatnam (IN); Shikhar Kwatra, San Jose, CA (US); Jeremy R. Fox, Georgetown, TX (US)

(21) Appl. No.: 17/662,742

(22) Filed: May 10, 2022

(51) Int. Cl. G06Q 10/06; G10L 15/22; G10L 15/30; G10L 15/18; G10L 25/63

(52) U.S. Cl. CPC G06Q 10/06393; G10L 15/22; G10L 15/30; G10L 15/1815; G10L 25/63

(57) ABSTRACT

A computer-implemented method, a computer system and a computer program product manage disruption between activities in a common area environment. The method includes capturing activity data from the common area environment, where the activity data is selected from a group consisting of: video data, audio data and biometric data and text data. The method also includes identifying a plurality of current activities in the activity data. Each current activity is associated with a device and includes a context with respect to other current activities in the plurality of current activities. In addition, the method includes determining a disruption score for each current activity in the plurality of current activities based on the context with respect to the other current activities. Lastly, the method includes transmitting a notification response to the device associated with a current activity when the disruption score for the current activity is above a threshold.

### BACKGROUND

Embodiments relate generally to the field of automated recognition of conversations or activities in common area environments, and more specifically, to managing potential disruption or interference between activities in common area environments through notifications or alerts.

When different individuals, or groups of individuals, in a common area environment, e.g., an office with an open work environment or a living room of a home, perform individual activities, associated sounds from one conversation or activity may create noise that may disrupt other conversations or activities. In these environments, some activities may be more or less disruptive, e.g., a group of employees engaged in a conversation about non-work related matter may disrupt another employee in the environment having a business conference call. Another example may be children playing games in a home while a parent may simultaneously attempt to work from home. In common area environments where individuals may be simultaneously performing different activities, disruption may be mitigated when the individuals are aware that disruption is being caused and take their conversation or other activity to an area that may be more private and separated from the common area environment such that the noise may be reduced.

### SUMMARY

An embodiment is directed to a computer-implemented method for managing disruption between activities in common area environments. The method may include capturing activity data from the common area environment. The activity data may be selected from a group consisting of: video data, audio data and biometric data and text data. The method may also include identifying a plurality of current activities in the activity data. Each current activity may be associated with a device and may include a context with respect to other current activities in the plurality of current activities. The method may further include determining a disruption score for each current activity in the plurality of current activities based on the context with respect to the other current activities. Lastly, the method may include transmitting a notification response to the device associated with a current activity when the disruption score for the current activity is above a threshold.

In another embodiment, the method may include identifying a participant in each current activity. In this embodiment, the participant may be associated with a participant device. In this embodiment, the method may also include determining that the participant handles sensitive information based on a user profile of the participant. Lastly, in this embodiment, the method may include transmitting the notification response to the participant device.

In a further embodiment, the identifying the plurality of current activities in the activity data may include identifying a plurality of utterances associated with each current activity. In this embodiment, the identifying the plurality of current activities in the activity data may also include determining whether each utterance of the plurality of utterances associated with each current activity includes sensitive information. Lastly, in this embodiment, the identifying the plurality of current activities in the activity data may include storing the utterance on a server in response to an utterance associated with each current activity not including the sensitive information.

In yet another embodiment, a machine learning model that determines an intent of a conversation based on a tone of voice used by participants in the conversation and a natural language processing analysis of the conversation may be used to determine the context with respect to other activities of each current activity.

In another embodiment, a machine learning model that predicts a level of disruption for an activity with respect to other activities in a common area based on the context and a noise level may be used to determine the disruption score for each current activity in the plurality of current activities.

In a further embodiment, the notification response is transmitted to a device that is associated with the common area environment.

In an additional embodiment, the threshold may be a difference between a first disruption score for a first current activity and a second disruption score for a second current activity.

In addition to a computer-implemented method, additional embodiments are directed to a system and a computer program product for managing disruption between activities in common area environments.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a flow chart diagram for a process that manages disruption between activities in a common area environment according to an embodiment.

FIG. 3 depicts a cloud computing environment according to an embodiment.

FIG. 4 depicts abstraction model layers according to an embodiment.

### DETAILED DESCRIPTION

It may be common for individuals to gather in common areas such as an open collaborative space in an office or a living room in a home. In such environments, individuals or groups of individuals may be simultaneously performing different activities, e.g., children may be playing games or co-workers may be engaged in conversation or another employee may be attempting to connect to a conference call or meeting using a mobile device such as a telephone or laptop computer. Depending on the overall environment and the activities being performed, one group may cause disruption to other groups and may or may not be aware of both the disruption that may be caused and the source of the disruption. For instance, in a work from home environment, a group of children may be watching television or playing games and be unaware that a parent may be attempting to host a meeting in a nearby room. Another example may be a group of co-workers in an open collaborative office that may be taking a break from work and having a conversation with one another, while another employee may be trying to connect to an important meeting in an adjoining space. In such scenarios, while it may be possible for these activities to co-exist by ignoring the noise and potential disruption or to overcome the noise because of the design of the space, it is more likely that activities that may be less important or sensitive will disrupt activities that may have a higher importance or sensitivity. For example, the noise of children playing in the house may disrupt an adult participating on a conference call from a home office.

It may be useful to provide an automated method or system that may detect and identify distinct activities within the common area, rank those activities by the potential for disruption to other activities within the common area, and provide alerts or notifications to individuals participating in the activities within the common area that may inform them of potential disruption or request that the individual or group move away from the common area. Such a method or system may intelligently analyze and differentiate speech tone among different heterogeneous noises using contextual Internet of Things (IoT) devices, e.g., cameras or microphones that may be fixed in the environment or embedded within mobile devices that may or may not be registered with such a system, to collect the information. The method or system may then apply artificial intelligence (AI) and machine learning (ML) to rank each distinct activity by the level of disruption that may be caused by the activity. The level of disruption may be predicted by the machine learning model using an appropriate method and may be trained using data that may be collected over time prior to the current analysis. It is important to note that the level of disruption may be distinct and separate from a sensitivity or importance of an activity, meaning that if children are playing quietly or if a casual conversation in a common area is limited in participants or noise, that activity may still get a low disruption score even if other activities in the space are important meetings or the like. Similarly, if an executive board meeting is loud and causing disruption to others, then that activity may receive a high disruption score, even if it may be the most important activity of all the detected and analyzed activities. Once disruption scores may be determined for all activities in a common area and the activities may be ranked, the method or system may communicate an appropriate alert or notification to individuals participating in those activities with a disruption score above a threshold that may be determined by the method or system. Such an alert or notification may be in the form of an audible alert over a speaker in the common area or a video alert on a screen in the area or may also be provided through a mobile device that may be connected to a participating individual that may have been registered with the method or system. Such an alert or notification may provide direction that enables participating individuals to effectively carry out the detected and analyzed activities in the common area.

Such a method or system may use the contextual IoT devices (e.g., smart phone, smart TV, digital assistant, etc.) in the environment to identify the voices of speakers in the common area by identifying specific words uttered as well as the tone of voice. For example, during play, children may frequently laugh, while participants in a business meeting may have steady and quiet discussions. In addition, the vocabulary in a meeting may be more technical (e.g., “need to expedite”, “number of resources needed”, “when can the work be completed”, etc.).

It also should be noted that monitoring user conversations (e.g, using a microphone in an “always-listening” mode) as used herein requires the informed consent of all people whose conversations are captured for analysis. Consent may be obtained in real time or through a prior waiver or other process that informs a subject that their voice will be captured by a microphone and that the audio will be analyzed by a speech recognition algorithm and natural language processing.

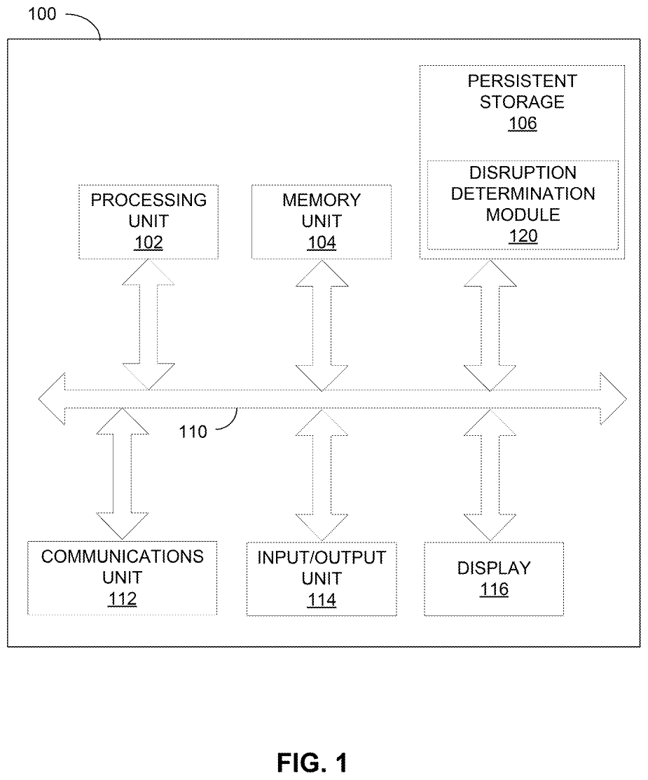

Referring now to FIG. 1, there is shown a block diagram illustrating a computer system 100 in accordance with an embodiment. It should be appreciated that FIG. 1 provides only an illustration of one implementation and does not imply any limitations with regard to the environments in which different embodiments may be implemented. Many modifications to the depicted environments may be made based on design and implementation requirements. For example, computer system 100 may be implemented in hardware only, software only, or a combination of both hardware and software. Computer system 100 may have more or fewer components and modules than shown, may combine two or more of the components, or may have a different configuration or arrangement of the components. Computer system 100 may include any additional component enabling it to function as an operable computer system, such as a motherboard, data busses, power supply, a network interface card, a display, an input device (e.g., keyboard, pointing device, touch-sensitive display), etc. (not shown). Moreover, components of computer system 100 may be co-located or distributed, or the system could run as one or more cloud computing “instances,” “containers,” and/or “virtual machines,” as known in the art.

As shown, a computer system 100 includes a processor unit 102, a memory unit 104, a persistent storage 106, a communications unit 112, an input/output unit 114, a display 116, and a system bus 110. Computer programs such as the conversational agent 120 may be stored in the persistent storage 106 until they are needed for execution, at which time the programs are brought into the memory unit 104 so that they can be directly accessed by the processor unit 102. The processor unit 102 selects a part of memory unit 104 to read and/or write by using an address that the processor unit 102 gives to memory unit 104 along with a request to read and/or write. Usually, the reading and interpretation of an encoded instruction at an address causes the processor unit 102 to fetch a subsequent instruction, either at a subsequent address or some other address. The processor unit 102, memory unit 104, persistent storage 106, communications unit 112, input/output unit 114, and display 116 interface with each other through the system bus 110.

Examples of computing systems, environments, and/or configurations that may be represented by the data processing system 100 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Each computing system 100 may also include a communications unit 112 such as TCP/IP adapter cards, wireless Wi-Fi interface cards, or 3G or 4G wireless interface cards or other wired or wireless communication links. Communication between mobile devices may be accomplished via a network and respective network adapters or communication units 112. In such an instance, the communication network may be any type of network configured to provide for data or any other type of electronic communication. For example, the network may include a local area network (LAN), a wide area network (WAN), a virtual private network (VPN), a mobile or cellular telephone network, the Internet, or any other electronic communication system. The network may use a communication protocol, such as the transmission control protocol (TCP), the user datagram protocol (UDP), the internet protocol (IP), the real-time transport protocol (RTP) the Hyper Text Transport Protocol (HTTP), or a combination thereof.

The computer system 100 may be used for detecting and identifying activities in a common area environment and predicting how the activities may co-exist with each other, specifically determining a level of disruption that any one activity may cause to the other activities in the common area environment. In particular, a disruption determination module 120 may be implemented within persistent storage 106 that may detect activities in a common area using devices such as microphones or cameras or raw data, including text, from devices that may be in the common area and may or may not be registered in an overall system. Each activity that may be detected in the common area environment may be assigned a disruption score that may indicate a prediction for a potential level of disruption that may be caused by the activity. Such a prediction may take into account various attributes of the activity, including a noise level or the type of activity or possibly the participants in the activity, and also adjust to the other activities in the common area environment for which predictions are being generated. For instance, a loud conversation may be predicted to have a high potential for disruption if there are many other activities in the common area environment but if there are no other activities currently detected in the common area environment, the potential for disruption may be low. Activities in the common area environment may be ranked by the assigned disruption score and those activities that may have a score above a predetermined threshold, an alert or notification may be generated, either as a general warning in the common area or as a targeted message to a mobile device that may be connected to the activity. Such an alert or notification may be used by participants in the relevant activity to move away from the common area or perhaps end the activity.

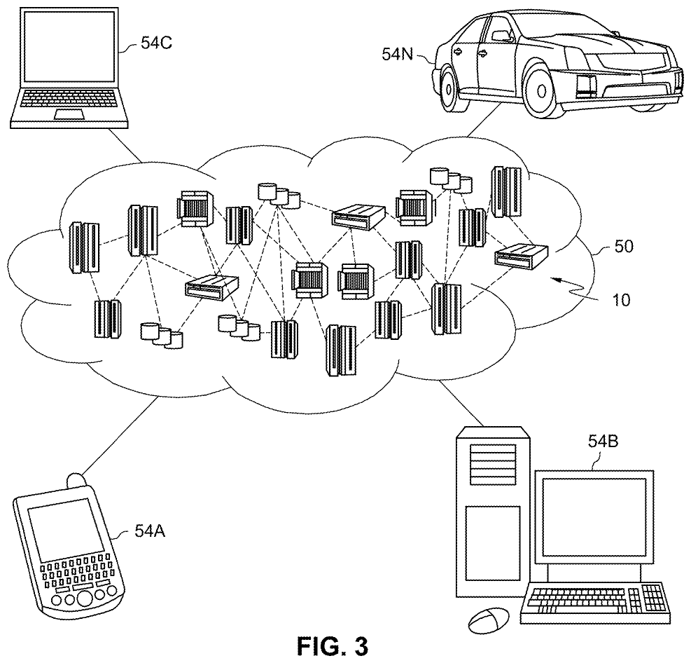

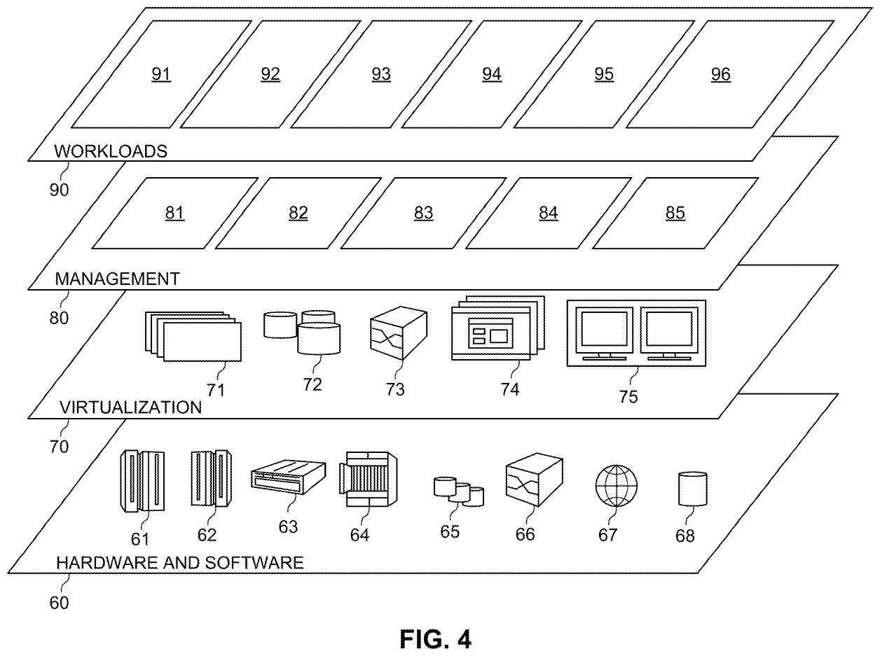

As will be discussed with reference to FIGS. 3 and 4, computing system 100 may also operate in a cloud computing service model, such as Software as a Service (SaaS), Platform as a Service (PaaS), or Infrastructure as a Service (IaaS). Any computing system 100 may also be located in a cloud computing deployment model, such as a private cloud, community cloud, public cloud, or hybrid cloud.

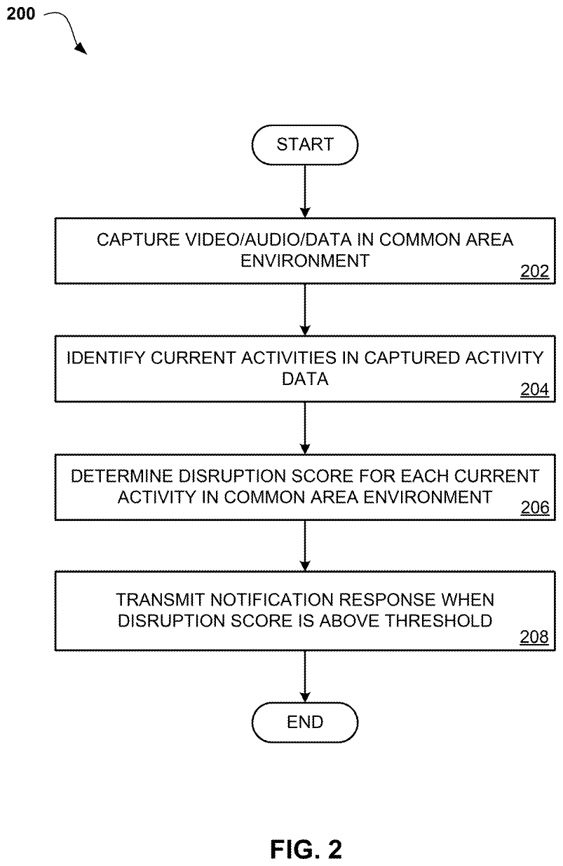

Referring to FIG. 2, an operational flowchart illustrating a process 200 that manages disruption between activities in common area environments is depicted according to at least one embodiment. At 202, audio or video, or data from Internet of Things (IoT) devices, may be captured in a common area environment using an appropriate device. Examples of appropriate devices may include a microphone, fixed or non-fixed, that may be placed nearby to capture voices participating in a conversation that may be occurring in the common area environment.

In an embodiment, the microphone may be in an “always-listening” mode, such that no trigger is required to begin audio capture and/or recording. The microphone may also, at the option of a user or administrator of the common area environment, be switched out of an “always-listening” mode (e.g., have the “always-listening” mode turned off). The same method of recording may be used with a camera to capture video in the common area environment. In addition to video or audio, devices within the common area environment may be set to transmit data, e.g., biometric information about an individual within the common area environment or text messages that may be sent to or from at least one individual in the common area environment. It is not necessary for there to be many devices under control but rather that there be a mechanism for accepting voice or video input, or text and other data, from the common area environment. For instance, microphones or cameras or other devices may be mounted within the common area environment in conspicuous or inconspicuous locations, such as within a collaborative space such as a conference room in an office or perhaps a cafeteria in an office building. One alternative to fixed devices in a location may be devices embedded in a smartphone or other mobile device that is carried by an individual within the common area environment, which may include a microphone or camera or even biometric data if the owner of the smartphone has a sensor attached and a corresponding application running on the smartphone. One of ordinary skill in the art would appreciate that one or more devices may be arranged in multiple ways to capture activities that may be occurring within a common area environment.

Any audio or video or other data that may be captured at this step may be stored, subject to the user consent restrictions described above and also contingent on whether the data may include sensitive information as described below, to allow for a processing buffer in identifying an activity and predicting disruption with other activities in the common area environment.

At 204, current activities may be identified within the data captured from the common area environment in 202. These current activities may be in many forms depending on the overall common area environment from which the data may be captured. For instance, in an office environment that may include collaborative spaces and conference rooms, as well as a cafeteria or other common areas such as hallways, current activities may be in the form of one or more people, or participants, coming together for conversations. These conversations may be related to work and include language that is more technical in nature or may be unrelated to work and involve topics or activities that may be experienced in personal lives, e.g., arranging a future meal or discussion of an athletic event that may have recently passed. In a home environment where the common area may be a living room or kitchen or other open space, current activities may be similarly work-related but may also include activities such as children or adults not involved in the workplace attempting to play games or conduct conversations that are entirely unrelated to a professional setting. These examples are meant to show the variety of current activities that may be identified within a common area environment and is not meant to be exhaustive.

In identifying current activities within a common area environment, the speaker of a given utterance may also be identified using speaker recognition algorithms that analyze tone of speech, voice print or voice quality and compare to a database or user profile. Another possible method to identify the speaker may be a combination of a Mel Frequency Cepstral Coefficient (MFCC) model and Gaussian Mixture Model (GMM). This list of possible methods for determining speaker identity is not intended to be exhaustive and one of ordinary skill in the art will appreciate that there are many ways to identify speakers. Any audio data that may have been captured may be converted to text using automatic speech recognition (ASR) algorithms at this stage, in addition to using natural language processing algorithms to recognize the meaning of an utterance such that it may be determined whether information in the conversation is considered to be sensitive. This may be accomplished by classifying information within each utterance as sensitive or not. Sensitive information may be filtered from extraction or logging and therefore prevented from being retained or sent to a remote server. Information classified as not sensitive may be forwarded for further processing.

The decisions for filtering content may be set by an owner of sensitive information or with training data that may be put into a classification model. The filter, or the ability to mark information as sensitive or not sensitive with respect to the machine learning classifier, may be configured for the information to be transmitted to the cloud server or may be configured for each piece of the intent information. In an initial state, transmission of all pieces of information may be disabled and only logging of information may be performed, such that no information may be sent to the cloud server. This default initial setting means the owner of the potentially sensitive information is required to consent to any information being retained or transmitted over a network.

The information owner may check the logged information via a user interface (UI) provided at the edge server or via a mobile device such as a smartphone or tablet and confirm what information may be transmitted to the cloud server, and therefore what information may be classified as sensitive. The information owner may also test what services may be received by disclosing that information by selecting logged text data and transmitting that data to the cloud server to decide whether to approve transmission of certain information, or manually mark that information according to sensitivity. If the information owner approves transmission via these filter settings, only the information that is approved may be transmitted to the cloud server. Any sensitive information will still be classified as such and blocked from retention or transmission.

It should be noted that the information owner is free to make these decisions at any time and change what they choose to be sensitive information as these settings are permanently retained to keep the machine learning classifier updated with the latest information and also allow the owner of the information complete control over their informed consent to use sensitive information to retrieve advanced services.

To make decisions on the audio that is captured in real time with respect to sensitivity, natural language processing (NLP) algorithms may be used on the text data that comes from the speech to text conversion. Generally, the NLP process takes textual input (such as the output of the ASR process described above based on the utterance input audio) and attempts to make a semantic interpretation of the text. That is, the NLP process determines the meaning behind the text based on the individual words and then implements that meaning. if a spoken utterance is processed using ASR as described above and results in the text “my credit card number is 1234”, an NLP algorithm may determine that credit card numbers are sensitive information and classify the information as sensitive.

In addition to identifying specific current activities and/or a speaker in a conversation in a current activity, a device may be identified and associated with each current activity. The device may be pre-registered with the system prior to collection of activity data from common area environment or at any time as it is not necessary for devices to be registered. The device that may be associated with the current activity may be one of the devices that may be used to collect activity data, but this is also not required. In addition, multiple devices may be identified and associated with a current activity, just as a single device may be associated with multiple activities. The device that may be identified for the current activity may be a default device associated with a person who has been identified as a speaker in the current activity or may be a device that may be associated with the common area as a whole, such as a screen or a loudspeaker. It is only required that at least one device is identified and associated for each current activity for the purpose of receiving potential notification responses in the event that the current activity is determined to be disruptive.

At 206, each conversation may be assigned a disruption score based on the potential disruption to the other conversations that may be identified in the common area environment. Such a disruption score may represent a confidence in a prediction of the disruption that a current activity in the common area environment may cause to other activities in the common area. Such a prediction may depend on several factors, including a context of the current activity, which may itself be a function of the importance or priority of the activity, e.g., a technical work discussion in an open work area may have a higher importance than a non-work conversation in the same common area or children playing a game may have lower importance than a parent conducting a work meeting in a home office scenario. In addition to context, a noise level or loudness measure may be taken of the activity as another factor. It is important to note that the priority or importance of a current activity, while one of the factors in the determination of a disruption level or score, is not equivalent to the disruption score. Disruption may be caused by loud activities that have a high priority, just as little or no disruption may be caused by low-priority activities that may be conducted quietly. At this step, current activities that may have been detected may be ranked by the disruption score that may be assigned, such that a hierarchy may be formed that may indicate which current activities in the common area may be causing the most, or least, disruption.

In an embodiment, a supervised machine learning model may be trained to predict disruption to other conversations based on attributes of the speakers, such as volume or tone of voice, or the specific words that may be used by speakers in the conversation or any other aspect of the conversation that may be detected in the captured data. One or more of the following machine learning algorithms may be used: logistic regression, naive Bayes, support vector machines, deep neural networks, random forest, decision tree, gradient-boosted tree, multilayer perceptron, and one-vs-rest. In an embodiment, an ensemble machine learning technique may be employed that uses multiple machine learning algorithms together to assure better prediction when compared with the prediction of a single machine learning algorithm. In this embodiment, training data for the model may include prior activities that may have been detected in the current common area or any other common area environment that may have had multiple activities occurring. The training data may be collected from a single example user or a group of users, with user consent required prior to collection of any data from human users. The prediction results may be stored in a database so that the data is most current, and the output would always be up to date.

It should be noted that a separate machine learning model that may operate in the same way as described here may also be used to predict the context of a current activity, which includes the priority or importance of the current activity but also may take into account the other current activities in the common area and adjust the prediction of priority or importance based on the other activities that may be occurring in the common area environment. Such a model may depend on similar, or even the same, training data as what may be used to train the above machine learning model and, just as with the first machine learning model, requires user consent prior to collection.

At 208, a notification response may be transmitted to a device associated with the current activity for disruption scores above a threshold. The purpose of the notification response may be to alert or notify participants in a current activity that the current activity has been identified as being too disruptive and the activity should move to another part of the common area environment or out of the environment altogether. The device associated with the current activity may be the device identified above and may include a mobile device belonging to a participant or to a device that may be associated with the overall common area environment. One of ordinary skill in the art may understand that there may be multiple devices that may be associated with a current activity, and it is not required that the notification response take a specific form, but rather the notification response should inform the participants in the current activity that the current activity should be moved as described above. The alert or notification that may be transmitted may be a text message or may be a vibration or audible sound that alerts or notifies one or more participants in a current activity that may have been identified as too disruptive.

The threshold that may be applied to the disruption scores at this step may be a predefined value above which all current activities may be classified as requiring a notification response, in which case the notification response may be sent to the associated device for those current activities. Another possible method for determining a threshold may be to compare disruption scores among current activities in the common area and, in the event of a wide disparity between sets of current activities, a notification response may be sent to the device associated with the current activities that have the higher disruption scores. In this embodiment, the threshold may not be a set value for the score but rather a minimum difference between one or more disruption scores.

In addition to transmitting a notification response when the disruption score is above a threshold, the disruption determination module 120 may also look to a user profile after a speaker is determined for certain utterances within a conversation as part of an identified current activity. This user profile may indicate that the speaker handles sensitive information in the course of that person's daily work and therefore, it is likely that a current activity involving the identified speaker will include sensitive information. In that event, a notification response may be transmitted to the device associated with the activity, or simply to a device associated with that user directly, indicating that the user should move to a more secure area that is away from the common area environment. In this embodiment, the identification of the current activity and determination of disruption score may be bypassed any time that a specific participant may be identified as a participant in a current activity within the common area environment.

To ensure that highest level of quality assurance within the task priority assignment, both qualitative and quantitative data may be used. Through the application of fuzzy logic, task priority assignment qualitative data may be included and transformed into quantitative data. One issue that has been noted in existing task priority assignment tools in general is the quality and availability of data, with some users or clients entering minimal or no data into their task priority assignment tools. Our invention will utilize machine learning algorithms may be used to determine likely values for missing data and provide recommendations for entering accurately the missing data. Such machine learning may therefore solve issues in data input and provide the machine learning model with new complete data sets to learn from with respect to task priority assignment. The enhanced data output may result in enhanced decision-making at the aggregate level pertaining to that particular type of task priority assignment for that specific environment or ecosystem. Through the use of fuzzy logic, the machine learning model may incorporate provide recommendations on how to categorize, prioritize and identify dependencies between task priority assignment in a portfolio and further transform the qualitative data into quantitative data that may be utilized for clear and present value via a feedback loop to the ecosystem. As a result, task priority assignment qualitative data inputs may be transformed into actionable quantitative outputs through the utilization of fuzzy logic to aid in drawing any specific conclusions based on data types and inputs.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66, such as a load balancer. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and managing disruption between activities in a common area environment 96, which may refer to identifying current activities in a common are environment and transmitting notification responses to those current activities that are determined to be too disruptive.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing disruption between activities in a common area environment, the method comprising:
capturing activity data from the common area environment, wherein the activity data is selected from a group consisting of: video data, audio data and biometric data and text data;
identifying a plurality of current activities in the activity data, wherein each current activity is associated with a device and includes a context with respect to other current activities in the plurality of current activities;
determining a disruption score for each current activity in the plurality of current activities based on the context with respect to the other current activities; and
transmitting a notification response to the device associated with a current activity when the disruption score for the current activity is above a threshold.

2. The computer-implemented method of claim 1, further comprising:
identifying a participant in each current activity, wherein the participant is associated with a participant device;
determining that the participant handles sensitive information based on a user profile of the participant; and
transmitting the notification response to the participant device.

3. The computer-implemented method of claim 1, wherein the identifying the plurality of current activities in the activity data comprises:
identifying a plurality of utterances associated with each current activity;
determining whether each utterance of the plurality of utterances associated with each current activity includes sensitive information; and
in response to an utterance associated with each current activity not including the sensitive information, storing the utterance on a server.

4. The computer-implemented method of claim 1, wherein a machine learning model that determines an intent of a conversation based on a tone of voice used by participants in the conversation and a natural language processing analysis of the conversation is used to determine the context with respect to other activities of each current activity.

5. The computer-implemented method of claim 1, wherein a machine learning model that predicts a level of disruption for an activity with respect to other activities in a common area based on the context and a noise level is used to determine the disruption score for each current activity in the plurality of current activities.

6. The computer-implemented method of claim 1, wherein the notification response is transmitted to a device that is associated with the common area environment.

7. The computer-implemented method of claim 1, wherein the threshold is a difference between a first disruption score for a first current activity and a second disruption score for a second current activity.

8. A computer system for managing disruption between activities in a common area environment, comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
capturing activity data from the common area environment, wherein the activity data is selected from a group consisting of: video data, audio data and biometric data and text data;
identifying a plurality of current activities in the activity data, wherein each current activity is associated with a device and includes a context with respect to other current activities in the plurality of current activities;
determining a disruption score for each current activity in the plurality of current activities based on the context with respect to the other current activities; and
transmitting a notification response to the device associated with a current activity when the disruption score for the current activity is above a threshold.

9. The computer system of claim 8, further comprising:
identifying a participant in each current activity, wherein the participant is associated with a participant device;
determining that the participant handles sensitive information based on a user profile of the participant; and
transmitting the notification response to the participant device.

10. The computer system of claim 8, wherein the identifying the plurality of current activities in the activity data comprises:
identifying a plurality of utterances associated with each current activity;
determining whether each utterance of the plurality of utterances associated with each current activity includes sensitive information; and
in response to an utterance associated with each current activity not including the sensitive information, storing the utterance on a server.

11. The computer system of claim 8, wherein a machine learning model that determines an intent of a conversation based on a tone of voice used by participants in the conversation and a natural language processing analysis of the conversation is used to determine the context with respect to other activities of each current activity.

12. The computer system of claim 8, wherein a machine learning model that predicts a level of disruption for an activity with respect to other activities in a common area based on the context and a noise level is used to determine the disruption score for each current activity in the plurality of current activities.

13. The computer system of claim 8, wherein the notification response is transmitted to a device that is associated with the common area environment.

14. The computer system of claim 8, wherein the threshold is a difference between a first disruption score for a first current activity and a second disruption score for a second current activity.

15. A computer program product for managing disruption between activities in a common area environment, comprising:
a computer readable storage device having program instructions embodied therewith, the program instructions executable by a processor to cause the processor to perform a method comprising:
capturing activity data from the common area environment, wherein the activity data is selected from a group consisting of: video data, audio data and biometric data and text data;
identifying a plurality of current activities in the activity data, wherein each current activity is associated with a device and includes a context with respect to other current activities in the plurality of current activities;
determining a disruption score for each current activity in the plurality of current activities based on the context with respect to the other current activities; and
transmitting a notification response to the device associated with a current activity when the disruption score for the current activity is above a threshold.

16. The computer program product of claim 15, further comprising:
identifying a participant in each current activity, wherein the participant is associated with a participant device;
determining that the participant handles sensitive information based on a user profile of the participant; and
transmitting the notification response to the participant device.

17. The computer program product of claim 15, wherein the identifying the plurality of current activities in the activity data comprises:
identifying a plurality of utterances associated with each current activity;
determining whether each utterance of the plurality of utterances associated with each current activity includes sensitive information; and
in response to an utterance associated with each current activity not including the sensitive information, storing the utterance on a server.

18. The computer program product of claim 15, wherein a machine learning model that determines an intent of a conversation based on a tone of voice used by participants in the conversation and a natural language processing analysis of the conversation is used to determine the context with respect to other activities of each current activity.

19. The computer program product of claim 15, wherein a machine learning model that predicts a level of disruption for an activity with respect to other activities in a common area based on the context and a noise level is used to determine the disruption score for each current activity in the plurality of current activities.

20. The computer program product of claim 15, wherein the notification response is transmitted to a device that is associated with the common area environment.
